(19) United States
(12) Patent Application Publication
(10) Pub. No.: US 2008/0272711 A1
(43) Pub. Date: Nov. 6, 2008

(54) Apparatus and Method for Eliminating Electric Arc

(75) Inventors: Peide Wu, Shanghai (CN); Zhong Chen, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,300

(22) PCT Filed: Aug. 4, 2005
(86) PCT No.: PCT/IB2005/052600

§ 371 Date: Aug. 20, 2007

(30) Foreign Application Priority Data
Aug. 11, 2004 (CN) 200410057881.7

(51) Int. Cl. H05B 41/36

(52) U.S. Cl. 315/291

(57) ABSTRACT

The present invention relates to an apparatus and a method for eliminating electric arc in the field of lighting electronics. Whether or not electric arc is likely to be produced is determined through monitoring the current variation in the lighting circuit loop. If electric arc is likely to be produced, the lighting circuit loop is disconnected for a preset period of time to eliminate the voltage condition for producing electric arc so as to eliminate electric arc. Beyond the preset time when the lighting circuit loop is disconnected, the lighting circuit loop is connected normally, and works normally and unaffectedly.

### BACKGROUND OF THE INVENTION

This invention generally relates to lighting electronics, and more particularly to an apparatus and a method for eliminating electric arc.

In the fluorescent lamp lighting, one of the important functions of the existing electronic ballast is to immediately start a connected fluorescent lamp. To this end, when a fluorescent lamp is not put in a lamp holder, the electronic ballast normally has to maintain a relatively high voltage (e.g. 600V) at the contacts of live connection with fluorescent lamp at the lamp holder. After fluorescent lamp is connected to the lamp holder and turned on, this voltage will automatically drop to a relative low level, namely the conduction working voltage of the fluorescent lamp.

During the time when no fluorescent lamp is put in, the high voltage kept at the contacts of live connection at the lamp holder would cause some factors of un-safety. For example, when a fluorescent lamp is connected or disconnected, between the pins of a fluorescent lamp and the live connection at the lamp holder electrical arc would be produced. When serious, the electric arc will endanger the personal and property safety of a user.

To ensure safety, many product safety certifying organizations (such as the US Underwriters Laboratories Inc.) require that the electronic ballasts pass the Arcing Test, otherwise they will refuse to issue the corresponding safety certificates. Lack of the corresponding safety certification would surely affect the market development of the products.

To prevent the production of electric arc when one puts in or takes down a fluorescent lamp, some electronic ballast manufacturers have developed electronic ballasts capable of preventing or eliminating the production of electric arc. However, they have done it at the cost of some good performances of the electronic ballasts (e.g. those of total harmonic distortion or electromagnetic interference) or with the result of making electronic ballasts directly lose the function of instantly and automatically starting connected fluorescent lamps.

Therefore, it is necessary to provide an apparatus and a method for eliminating electric arc that can eliminate electric arc, ensure safety and will not affect the original good performance of the lighting circuit.

### SUMMARY OF INVENTION

The object of the present invention is to provide an apparatus and a method for eliminating electric arc at the live connection between a fluorescent lamp and a lamp holder in a lighting circuit in order to overcome the inadequacy of the prior art.

According to one embodiment of the present invention, an apparatus is provided for eliminating electric arc, comprising a monitor means for monitoring variation of electric signals in a lighting circuit loop and outputting a corresponding monitor signal; a comparison means for comparing said monitor signal with a pre-determined reference value to determine whether or not electric arc is likely to be produced in said lighting circuit loop and for outputting a trigger signal when said monitor signal reaches said pre-determined reference value; and a control means for disconnecting said lighting circuit loop for a preset period of time according to said trigger signal for the purpose of eliminating electric arc.

According to one embodiment of the present invention, an electronic ballast is provided, comprising a lighting circuit means for controlling the output of lighting electric signal; and an means for eliminating electric arc, comprising a monitor means for monitoring the variation of electric signals in a lighting circuit loop and outputting a corresponding monitor signal; a comparison means for comparing said monitor signal with a pre-determined reference value to determine whether or not electric arc is likely to be produced in said lighting circuit loop and for outputting a trigger signal when said monitor signal reaches said pre-determined reference value; and a control means for disconnecting said lighting circuit loop for a preset period of time according to said trigger signal for the purpose of eliminating electric arc.

According to one embodiment of the present invention, a method is provided for eliminating electric arc, including these steps: monitoring the variation of electric signals in the lighting circuit loop and producing a corresponding monitor signal; comparing said monitor signal with a pre-determined reference value to determine whether or not electric arc is likely to be produced in said lighting circuit loop; if said monitor signal reaches said pre-determined reference value, then producing a trigger signal; and disconnecting said lighting circuit loop for a preset period of time according to said trigger signal for the purpose of eliminating electric arc.

Through the apparatus and method provided by the present invention, once electric arc is produced between the live connection of a lamp holder and a fluorescent lamp, the lighting circuit loop is disconnected to make the condition for producing electric arc absent, so as to eliminate electric arc. After the lighting circuit loop is disconnected for a preset period of time, the lighting circuit loop is connected again for it to return to its normal working state, including starting and controlling the normal work of the fluorescent lamp put in, and, when no fluorescent lamp is put in, a high voltage is maintained at the contacts of live connection of the lamp holder for starting the put-in fluorescent lamp. The other performances of the lighting circuit are not affected in any way under the normal working state of the lighting circuit.

The present invention will be understood in a more comprehensive manner with the description made with reference to the appended drawings and the claims, with the object of the present invention and the modes to realize the object made clearer and more explicit.

### BRIEF DESCRIPTION OF THE DRAWINGS

A further detailed description is presented on the basis of the following appended drawings and the embodiments.

FIG. 1 is a block view of means 100 for eliminating electric arc according to one embodiment of the present invention;

FIG. 2 is an abridged general view demonstrating the connection of a means for eliminating electric arc with lighting circuit;

FIG. 3 is an abridged general view of the circuit demonstrating the connection of a means for eliminating electric arc with the lighting circuit;

FIG. 4 is an abridged general view depicting the variation in the value of electric signals at the five nodes in the lighting circuit shown in FIG. 3 in the process of operation of a means for eliminating electric arc according to the present invention; and

FIG. 5 is a flow chart of the method for eliminating electric arc according to an embodiment of the present invention.

The same reference number in the Figures indicate the identical, similar or corresponding features or functions.

### DETAILED DESCRIPTION OF THE SPECIFIC EMBODIMENTS

The inventive concept of the present patent goes as follows: electric arc produced between the pins of a fluorescent lamp and the contacts of live connection at a lamp holder because of taking down or putting on a fluorescent lamp cause relatively considerable variation (namely di/dt is high) in the output current in a lighting circuit loop; hence, it can be determined whether electric arc is likely to be produced through monitoring the variation rate of the lighting circuit. In the presence of electric arc produced, the lighting circuit loop is disconnected for a preset period of time (e.g. 100 ms) to remove the voltage condition for producing electric arc so as to eliminate electric arc. Within the preset period of time, the fluorescent lamp is in the process of being taken down, and it is not necessary for the lighting circuit loop to keep its electric performance of its normal operation; hence the lighting circuit loop can be disconnected. Outside the preset period of time, the lighting circuit loop is normally connected, and works normally and unaffectedly.

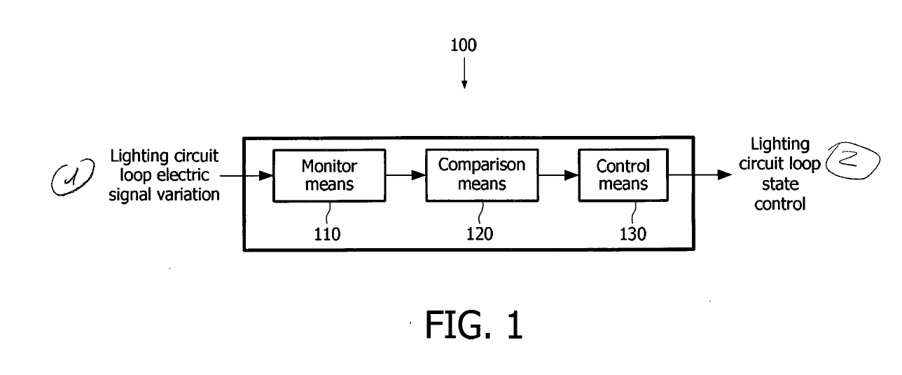

FIG. 1 is a block view of means 100 for eliminating electric arc according to one embodiment of the present invention. As is shown in FIG. 1, means 100 includes a monitor mean 110 for monitoring variation in electric signal in the lighting circuit loop and outputting a monitor signal. Monitor means 110 can monitor the current signal of the lighting circuit loop or the voltage signal of a particular resistance element. If electric arc is produced, there is relatively considerable variation (e.g. di/dt is high) in the electric signal that monitor means 110 has monitored in the lighting circuit. According to the monitor result, monitor means 110 will output a corresponding monitor signal.

Means 100 also includes a comparison means 120 for comparing monitor signal input from monitor means 110 with the pre-determined reference value and for outputting a trigger signal when the monitor signal reaches the pre-determined reference value. In the lighting circuit loop, besides electric arc, such factors as fluctuation of the network voltage will also cause variation of electric signal, but variation caused by these factors are usually relatively small. To determine whether electric signal variation is caused by electric arc or any other factor, there must be a pre-determined reference value to be compared with the monitor signal. When the monitor signal reaches the pre-determined reference value, it is deemed that electric arc has been produced in the lighting circuit loop (no matter whether electric arc has actually been produced in the circuit loop), and a trigger signal is output accordingly, otherwise it is deemed that the electric signal variation is within the normal fluctuation of the electrical signal in the lighting circuit loop.

Means 100 also includes a control means 130 for controlling the state of the lighting circuit loop according to the output comparison result of comparison means 120. If comparison means 120 outputs a trigger signal, it shows that electric arc has been or can be produced in the lighting circuit loop, then control means 130 will disconnect the lighting circuit loop to eliminate the corresponding voltage or make it drop (e.g. disconnecting the circuit between the rectification circuit and inversion circuit in the lighting circuit loop. etc.) to make absent the voltage condition for producing electric arc in order to eliminate electric arc.

If the lighting circuit loop remains disconnected, it will make fluorescent lamp put in impossible to be started immediately, nor make it work normally. For that matter, to enable the lighting circuit loop to return to its normal working state, it can be disconnected only for a preset period of time. When disconnection lasts to the end of the period, the lighting circuit loop will be connected again to ensure that fluorescent lamp connected in the lighting circuit can be immediately started and begin to work normally, or sufficiently high voltage is maintained to start the fluorescent lamp at the point of live connection of lamp holder in which no fluorescent lamp is put in.

Through the means provided by the present invention for eliminating electric arc, once electric arc is or can be produced in it, the lighting circuit loop will be disconnected and the voltage causing the production of electric arc is removed or drops so as to eliminate electric arc. The means provided by the present invention for eliminating electric arc will not affect the performance of the lighting circuit when it works normally. When a fluorescent lamp works normally, electric arc is likely to be produced if the pins of the fluorescent lamp is ill-connected to the lamp holder. In case like this, the means provided by the present invention for eliminating electric arc is activated to eliminate electric arc.

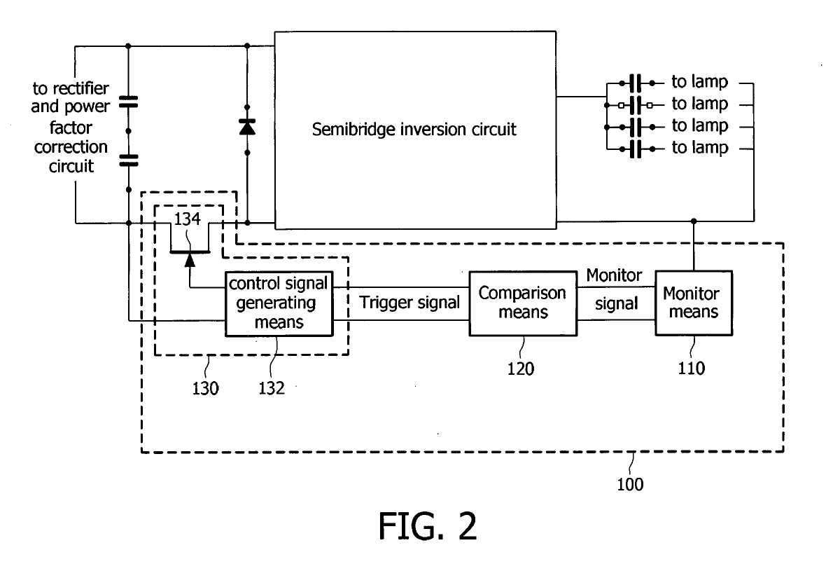

FIG. 2 is an abridged general view demonstrating the connection of a means for eliminating electric arc with the lighting circuit. As is shown in FIG. 2, monitor means 110 monitors variation of electric signals in the lighting circuit loop. This is normally realized by monitoring the variation of electric signal of the output circuit of the lighting circuit. For example, monitor means 110 may contain a mutual inductor connected to the output circuit of the lighting circuit put in, which, through one of its coil, can monitor the variation of electric signal of the output circuit of the lighting circuit, and induct a corresponding induction signal at the other coil of the mutual inductor.

Since the electrical signal variation caused by electric arc in the lighting circuit loop is usually pulsed signal variation and its amplitude is relative large (e.g. it can be as much as 20V or more), but lasts very short time (often only shorter than a microsecond), the induction signal inducted in the mutual inductor in monitor means 110 is also a similar pulsed signal. It is relatively difficult to use the inducted pulsed signal as a relatively stable signal. To make it possible to determine production of electric arc in the lighting circuit loop on the basis of the pulsed induction signal, monitor means 110 should process the induction signal, for example, by way of wave filtering and width modulation of an amplitude, and then outputs a monitor signal.

Comparison means 120 will compare monitor signal received from monitor means 110 with a pre-determined reference value, and outputs a trigger signal when the monitor signal reaches the pre-determined reference value. The trigger signal output by comparison means 120 can be a signal generated according to the result of the comparison. If the monitor signal reaches the pre-determined reference value, it outputs a trigger signal; if the monitor signal does not reach the pre-determined value, it outputs another signal different from the trigger signal. The trigger signal output by comprising means 120 may also be monitor signal input to comparison means 120 because when the monitor signal reaches the pre-determined reference value, it can reflect that electric arc is or can be produced in the lighting circuit loop.

After receiving a trigger signal from comparison means 120, control means 130 disconnects the lighting circuit loop, for example, disconnects the circuit between the rectification circuit and inversion circuit of the lighting circuit loop. As is shown in FIG. 2, control means 130 may include a control-signal-generating means 132 and a switch 134. Triggered by the input trigger signal, the control-signal-generating means 132 generates and outputs a control signal, which stops switch 134 for a preset period of time (e.g. 100 or 150 ms.) to disconnect the lighting circuit loop for said preset period of time.

Usually, the preset period of time is relatively short, e.g. 100 ms.; hence, within the present period of time, though the lighting circuit loop is disconnected, the electricity stored in the energy-storage elements (such as inductor or capacitor) in the lighting circuit loop would not make the voltage of the point of live connection at the lamp holder drop to zero because of the disconnected lighting circuit. Instead, the voltage remains at a relatively low level, which cannot meet the condition for producing electric arc. Therefore, electric arc is not to be produced between the lamp holder and the pins of the fluorescent lamp being taken down or put in. After the switch 134 is stopped for a preset period of time, it will connect the circuit according to the control signal, so that the lighting circuit loop returns to its state of connection, i.e. its normal working order.

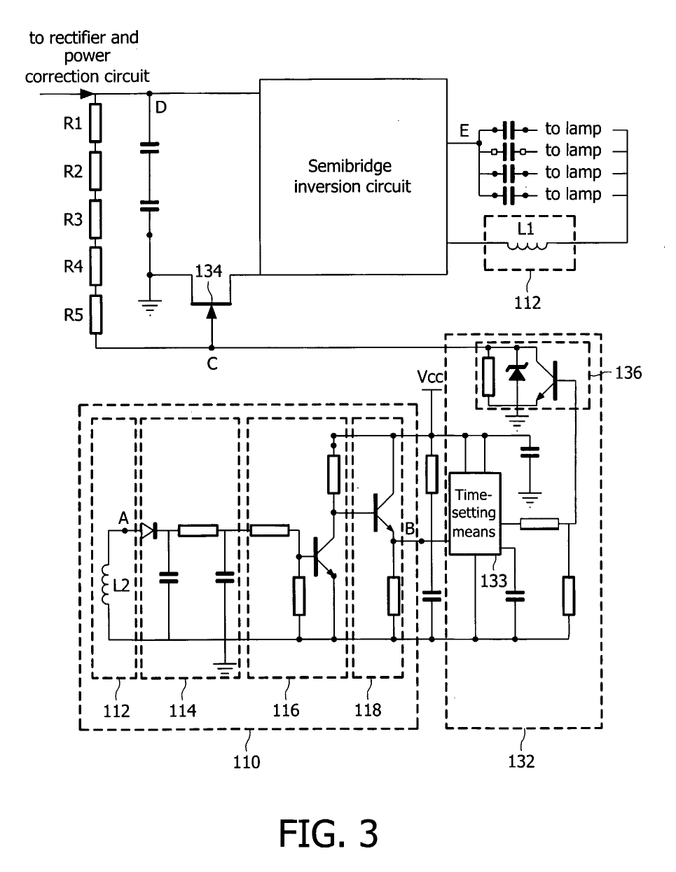

FIG. 3 is an abridged general view of circuit demonstrating the connection of a means for eliminating electric arc with lighting circuit. As is shown in FIG. 3, monitor means 110 includes mutual inductor 112 comprising coil L1 and coil L2 (in a particular circuit, L1 and L2 are adjacent to each other, so that L2 can induct the current variation of L1. To make FIG. 3 simple and neat, L1 and L2 are separated), Π-shaped electric filter 114, inverter circuit 116 and emitter-follower circuit 118. In the embodiment, the comparison function of comparison means 120 in the embodiment shown correspondingly to FIG. 1 is accomplished by the time-setting means 133 in control signal generating means 132. Control signal generating means 132 and switch 134 together form the control means to control the connection and disconnection of the lighting circuit loop. Comparison means 120 may also be an independent means for making comparison.

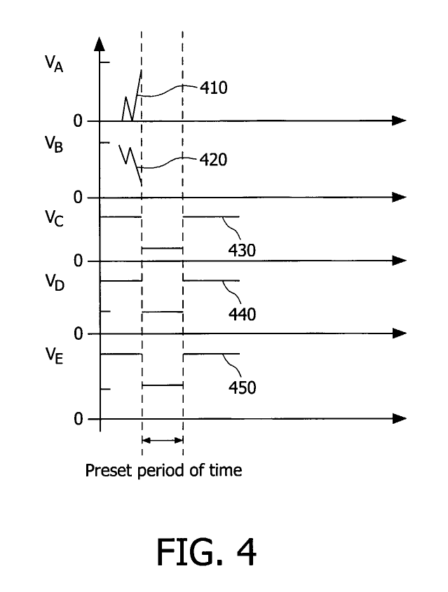

To clearly demonstrate the transmission and variation of the signals in FIG. 3, FIG. 4 presents a general view showing the variation of electric signal values V_{A}, V_{B}, V_{C}, V_{D} and V_{E} at the five nodes (A, B, C, D and E) of the lighting circuit shown correspondingly to FIG. 3.

If electric arc is produced in the lighting circuit loop in the cause of taking down or putting in a fluorescent lamp, then there will be relative considerable pulsed variation of the current signal in the output loop of the lighting circuit. This pulsed variation inducts the corresponding pulse signal at signal coil L2 through coil L1 of mutual inductor 112, such as the variation curve of pulse signal V_{A} at node A indicated by curve 410 in FIG. 4.

After it is filtered by Π-shaped electric filter 114, inverted by inverter circuit 116, and its interference is removed by emitter-follower 118, the pulse signal inducted by mutual inductor 112 (e.g. the pulse current signal V_{B} at node B indicated in curve 420 in FIG. 4) is input to time-setting means 133. The reason for the use of circuit 116 to do the inversion is that the time-setting means used in this embodiment is a negative trigger time-setter (e.g. the commonly used time setter 555). If the used time-setter does not need to be negatively triggered, then the means for eliminating electric arc does not need inverter circuit 116.

In the present embodiment, time-setting means 133 uses time setter 555, and it can be used to perform the comparison function, that is, comparing the monitor signal input from monitor means 110 with a pre-determined reference value. If the monitor signal reaches the pre-determined reference value, time-setting means 133 is triggered to work, otherwise, time-setting means 133 stands by.

After being triggered, time-setting means 133 outputs a control signal, which makes the gate of switch 134 connected to earth and comes to a stop through circuit 136 (e.g. the variation curve of signal V_{C} at node C indicated in curve 430 in FIG. 4), and consequently, the input of inversion circuit of the lighting circuit is disconnected, so that the voltage at node D of the lighting circuit is caused to drop (see the electric signal variation at node D shown by curve 440 in FIG. 4), and the corresponding voltage at node E of the output circuit of the corresponding lighting circuit (see the electric signal variation at node E shown in curve 450 in FIG. 4) suddenly drop, so that the voltage at the contacts of connection with fluorescent lamp at the lamp holder drops to such a level that electric arc cannot be produced.

It is the result of release of energy stored by the energy-storage elements (e.g. inductor or capacitor) in the circuit that the voltage at the live connection with fluorescent lamp at the lamp holder does not drop to zero when the lighting circuit loop is disconnected. If the preset time for disconnecting the lighting circuit is relative long, then the voltage at the live connection with fluorescent lamp at the lamp holder possibly drops to zero.

After the time of the disconnection of switch 134 reaches the preset time, time-setting means 133 no longer outputs time-setting control signal; hence circuit 136 comes to a stop and the voltage of the gate of switch 134 rises and conduction is effected, so that the lighting circuit returns to its normal working state. In the lighting circuit, five resistors R1-R5 are used to provide switch 134 with conduction voltage signal when the lighting circuit is in the state of conduction.

The means provided by the present invention for eliminating electric arc can be installed together with a conventional ballast to form a new ballast.

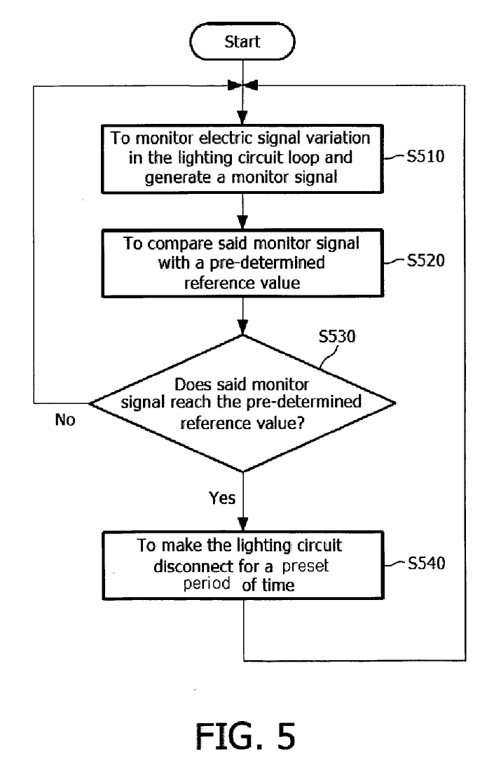

FIG. 5 is a flow chart of the method for eliminating electric arc according to an embodiment of the present invention. When the lighting circuit works, the electric signal variation in the lighting circuit loop is constantly monitored (step S510) to generate a corresponding monitor signal. The monitor signal is compared with a pre-determined reference value (step S520). It is determined on the basis of the result of the comparison whether or not electric arc can be produced in the lighting circuit loop (step S530), i.e. to determine whether or not the monitor signal reaches the pre-determined reference value. If the monitor signal reaches the pre-determined reference value, it is then deemed that electric arc has been produced in the lighting circuit, so the lighting circuit loop is disconnected for a pre-set period of time (step S540). After disconnected for a pre-set period of time, the lighting circuit is connected again and forms a loop in the normal working state.

Through the present invention, the voltage condition will be eliminated for producing electric arc in the lighting circuit, and the lighting circuit automatically returns to its normal working state after a certain period of time. This ensures safety and does not affect, in any way, the normal working state of the lighting circuit.

The present invention has been described above in combination with the embodiments. It is evident that those skilled in the art can obviously make all sorts of substitutions, modifications and changes on the basis of what has been described above. For that matter, all substitutions, modifications and changes of the nature should be in the spirit, and fall within the scope, of the claims of the present invention.

1. An apparatus for eliminating electric arc, comprising:
a monitor means for monitoring the variation of electric signals in a lighting circuit loop and outputting a corresponding monitor signal;
a comparison means for comparing said monitor signal with a pre-determined reference value to determine whether or not electric arc is likely to be produced in said lighting circuit loop and for outputting a trigger signal when said monitor signal reaches said pre-determined reference value; and
a control means for disconnecting said lighting circuit loop for a preset period of time according to said trigger signal for the purpose of eliminating electric arc.

2. The apparatus according to claim 1, wherein said monitor means includes a mutual inductor for monitoring current signal variation in said lighting circuit.

3. The apparatus according to claim 1, wherein said trigger signal includes monitor signal having reached said pre-determined reference value.

4. The apparatus according to claim 1, wherein said control means includes a control-signal-generating means and a switch means, and said control-signal-generating means outputs a control signal according to said trigger signal for making said switch means disconnected for said preset period of time.

5. The apparatus according to claim 4, wherein said control-signal-generating means includes a time-setting means for determining said preset period of time.

6. A ballast, comprising:
a lighting circuit means for controlling the output of lighting electric signal; and
a means for eliminating electric arc, including:
a monitor means for monitoring the variation of electric signals in a lighting circuit loop and outputting a corresponding monitor signal;
a comparison means for comparing said monitor signal with a pre-determined reference value to determine whether or not electric arc is likely to be produced in said lighting circuit loop and for outputting a trigger signal when said monitor signal reaches said pre-determined reference value; and
a control means for disconnecting said lighting circuit loop for a preset period of time according to said trigger signal for the purpose of eliminating electric arc.

7. The ballast according to claim 6, wherein said monitor means includes a mutual inductor for monitoring current signal variation in said light circuit.

8. The ballast according to claim 6, wherein said control means includes a control-signal-generating means and a switch means, and said control-signal-generating means outputs a control signal according to said trigger signal for making said switch means disconnected for said preset period of time.

9. The ballast according to claim 8, wherein said control-signal-generating means includes a time-setting means for determining the time for disconnection of said switch means is said preset period of time.

10. A method for eliminating electric arc, including these steps:
(a) monitoring the variation of electric signals in the lighting circuit loop and producing a corresponding monitor signal;
(b) comparing said monitor signal with a pre-determined reference value to determine whether or not electric arc is likely to be produced in said lighting circuit loop;
(c) if said monitor signal reaches said pre-determined reference value, then producing a trigger signal; and
(d) disconnecting said lighting circuit loop for a preset period of time according to said trigger signal for the purpose of eliminating electric arc.

11. A method according to claim 10, wherein said trigger signal including monitor signal having reached the pre-determined reference value.

12. A method according to claim 10, wherein said electric signal variation according to step (a) includes current signal variation.
